(19) United States
(12) Patent Application Publication
(10) Pub. No.: US 2009/0292033 A1
(43) Pub. Date: Nov. 26, 2009

(54) PROCESS FOR PRODUCING POROUS POLYMER PARTICLES

(75) Inventors: Takeo MATSUMURA, Osaka (JP); Kenjiro MORI, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi (JP)

(21) Appl. No.: 12/466,550

(22) Filed: May 15, 2009

(30) Foreign Application Priority Data
May 26, 2008 (JP) 2008-136393

(51) Int. Cl. C08J 9/28

(52) U.S. Cl. 521/123

(57) ABSTRACT

According to the invention, there is provided a process for producing porous polymer particles, which includes: dissolving in an organic solvent a monomer mixture containing an aromatic vinyl monomer and an aromatic divinyl monomer as major components together with a polymerization initiator to obtain a monomer solution; dispersing the monomer solution in water containing a dispersant and sodium nitrite to obtain a suspension polymerization dispersion; suspension-polymerizing the monomers in the suspension polymerization dispersion to yield porous polymer particles; and separating the porous polymer particles by filtration through a filter medium, in which the sodium nitrite is incorporated into the water in an amount in the range of 0.005 to 0.1 mg per 1 g of the water.

### FIELD OF THE INVENTION

The present invention relates to a process for producing porous polymer particles which are made of a copolymer of monomers mainly including an aromatic vinyl monomer and an aromatic divinyl monomer, preferably mainly including styrene and divinylbenzene, and can be suitable for use as a support for the solid-phase synthesis of a nucleic acid.

### BACKGROUND OF THE INVENTION

Porous particles of polystyrene-based polymers have hitherto been used as ion-exchange resins, adsorbent in various applications, supports for protein synthesis, etc. In recent years, these porous polymer particles are coming to be used also as supports for the synthesis of an anti-sense oligo-DNA, siRNA, or the like (see, for example, patent document 1). There is hence a desire for a process for more efficiently producing porous polymer particles having a lower impurity content.

Under such circumstances, suspension polymerization, in which operation is relatively easy, has so far been preferably employed as a technique for producing porous polymer particles. By suspension polymerization, porous polymer particles having any desired average particle diameter can be easily obtained. However, this polymerization technique has a drawback that the particles obtained have a relatively wide particle size distribution and, hence, the separation of the target porous polymer particles from the reaction mixture obtained by the suspension polymerization and washing for removing impurities require a lot of labor and time. There is also a problem that the production cost is high.

For separating target porous polymer particles from a reaction mixture obtained by the suspension polymerization, techniques such as centrifugal separation and centrifugal filtration have hitherto been used. In particular, suction filtration and pressure filtration, each of which employs a filter medium, are advantageous because these filtration techniques do not require a large-scale apparatus having a complicated structure and are low in power cost.

However, in the production of porous polymer particles by suspension polymerization, the efficiency of filtration for separating the target porous polymer particles decreases due to various causes including the followings. Namely, a finely particulate polymer generates unnecessarily in the aqueous phase and this polymer, when target porous polymer particles are taken out by filtration through a filter medium, clogs the filter medium to increase filtration resistance. There also are cases where the dispersant added to the aqueous phase for suspension polymerization, which includes a water-soluble polymer such as poly(vinyl alcohol) or polyvinylpyrrolidone, heightens the viscosity of the reaction mixture obtained by the suspension polymerization and this results in increased filtration resistance when the target porous polymer particles are taken out by filtration. Because of the reduced filtration efficiency caused by the above-mentioned reasons as well as other various reasons, the separation of the target porous polymer particles by filtration requires an exceedingly prolonged time period. In addition, for removing impurities contained in the porous polymer particles, it is necessary to repeatedly subject the particles to washing and filtration. Each time the filter medium is clogged in the course of the operation, the filter medium must be replaced with a fresh one, and such a replacement is troublesome.

Patent Document 1: JP-A-03-068593

### SUMMARY OF THE INVENTION

The invention has been achieved in order to solve the above-mentioned problems in the separation by filtration of porous polymer particles obtained by suspension polymerization. An object of the invention is to provide a process for efficiently filtering and washing a reaction mixture to effectively remove impurities and thereby obtain target porous polymer particles in high yield.

Namely, the invention provides the following items.

1. A process for producing porous polymer particles, which comprises:

dissolving in an organic solvent a monomer mixture comprising an aromatic vinyl monomer and an aromatic divinyl monomer as major components together with a polymerization initiator to obtain a monomer solution;

dispersing the monomer solution in water containing a dispersant and sodium nitrite to obtain a suspension polymerization dispersion;

suspension-polymerizing the monomers in the suspension polymerization dispersion to yield porous polymer particles; and

separating the porous polymer particles by filtration through a filter medium,

wherein the sodium nitrite is incorporated into the water in an amount in the range of 0.005 to 0.1 mg per 1 g of the water.

2. The process according to item 1, wherein an amount of the organic solvent in the suspension polymerization dispersion is in the range of 0.5 to 2.0 times by weight a total amount of the monomers.

3. The process according to item 1, wherein the aromatic vinyl monomer and the aromatic divinyl monomer account for at least 50% by weight of the monomer mixture.

4. The process according to item 1, wherein the aromatic vinyl monomer is styrene and the aromatic divinyl monomer is divinylbenzene.

5. The process according to item 1, wherein the monomer mixture includes p-acetoxystyrene.

6. The process according to item 1, wherein the dispersant is a poly(vinyl alcohol) having an average degree of polymerization in the range of 500 to 3,000 and a degree of saponification in the range of 65 to 85 mol %.

7. The process according to item 1, wherein the porous polymer particles have a median particle diameter in the range of 2 to 200 μm.

8. The process according to item 1, wherein the amount of the aromatic divinyl monomer is in the range of 2 to 30% by weight based on the total weight of the aromatic vinyl monomer and the aromatic divinyl monomer.

According to the process of the invention, by dissolving a slight amount of sodium nitrite in the water of a suspension polymerization dispersion, the suspension polymerization is inhibited from yielding a finely particulate polymer. Furthermore, target porous polymer particles naturally undergo secondary aggregation during the suspension polymerization or when the reaction mixture is cooled to room temperature after the suspension polymerization. Consequently, the reaction mixture obtained can be efficiently and easily filtered and washed and impurities can thus be effectively removed.

Namely, according to the process of the invention, the filtration of a reaction mixture obtained by suspension polymerization and the subsequent washing of the resultant porous polymer particles can be effectively conducted without causing clogging of the filter medium, so that porous polymer particles having a low impurity content can be efficiently obtained without the necessity of filter medium replacement in the course of the filtration and washing.

Furthermore, according to the process of the invention, the target porous polymer particles can be obtained in high yield.

### BRIEF DESCRIPTION OF THE DRAWING

FIG. 1 is a sectional view illustrating one example of filtration apparatuses suitable for use in filtering the reaction mixture obtained by suspension polymerization in the invention.

### DESCRIPTION OF REFERENCE NUMERALS

1: vessel

2: drainage opening

4: filter medium holding frame

5: filter medium support

6: filter medium

8: shaft

9: stirring blade

### DETAILED DESCRIPTION OF THE INVENTION

The process of the invention for producing porous polymer particles includes dissolving in an organic solvent a monomer mixture comprising an aromatic vinyl monomer and an aromatic divinyl monomer as major components together with a polymerization initiator to obtain a monomer solution; dispersing the monomer solution in water containing a dispersant and sodium nitrite to obtain a suspension polymerization dispersion; suspension-polymerizing the monomers in the suspension polymerization dispersion to yield porous polymer particles; and separating the porous polymer particles by filtration through a filter medium, wherein the sodium nitrite is incorporated into the water in an amount in the range of 0.005 to 0.1 mg per 1 g of the water.

In the invention, styrene or a substitution product thereof may be used as the aromatic vinyl monomer. Preferably, use may be made of a mixture including styrene as a main component and further including a styrene substitution product having any of various functional groups according to properties required for the target porous polymer particles.

Examples of such styrene substitution products include those having an alkyl group having 1-5 carbon atoms, halogen atom, amino, carboxyl, sulfo, cyano, alkoxy group having 1-5 carbon atoms, nitro, acyloxy group, or the like as a substituent. For example, porous polymer particles having a hydroxyl group can be efficiently obtained by conducting suspension copolymerization with the use of p-acetoxystyrene together with styrene as aromatic vinyl monomers, and hydrolyzing the polymer particles obtained with an alkali or acid.

In particular, examples of the aromatic vinyl monomer in the invention include styrene, nucleus-alkyl-substituted styrenes such as o-methylstyrene, m-methylstyrene, p-methylstyrene, 2,4-dimthylstyrene, ethylstyrene, and p-t-butylstyrene, α-alkyl-substituted styrenes such as α-methylstyrene and α-methyl-p-methylstyrene, nucleus-halogen-substituted styrenes such as chlorostyrene, and p-acetoxystyrene. However, the aromatic vinyl monomer should not be construed as being limited to these examples.

Examples of the aromatic divinyl monomer include divinylbenzene and divinylbenzene substitution products having any of various substituents as in the styrene substitution products enumerated above. In general, however, divinylbenzene and nucleus-alkyl-substituted divinylbenzenes such as methyldivinylbenzene are preferably used. Of these, divinylbenzene is particularly preferred. As the divinylbenzene, there may be used o-, m-, or p-divinylbenzene or a mixture of two or more thereof.

The monomer mixture in the invention includes the aromatic vinyl monomer and the aromatic divinyl monomer described above as major components. Namely, the monomer mixture in the invention may be one in which at least 50% by weight thereof is accounted for by the aromatic vinyl monomer and the aromatic divinyl monomer described above, the remainder being one or more other monomers. The monomer mixture may be one in which 100% by weight thereof is accounted for by the aromatic vinyl monomer and the aromatic divinyl monomer.

In the invention, however, the amount of the aromatic divinyl monomer is preferably in the range of 2 to 30% by weight, more preferably in the range of 5 to 20% by weight, based on the total weight of the aromatic vinyl monomer and the aromatic divinyl monomer. In case where the amount of the aromatic divinyl monomer based on the total weight of the aromatic vinyl monomer and the aromatic divinyl monomer is outside the range shown above, although it depends on combination with the organic solvent which will be described later, it is difficult to obtain truly spherical porous polymer particles. In addition, the porous polymer particles thus obtained do not have an even porous structure.

In the case where the aromatic vinyl monomer and the aromatic divinyl monomer in the invention are used together with one or more other monomers, preferred examples of the optional monomers include (meth)acrylic monomers such as acrylonitrile, acrylic acid, methacrylic acid, and methyl methacrylate.

According to the invention, a monomer mixture including the aromatic vinyl monomer and the aromatic divinyl monomer described above as major components is dissolved in an organic solvent together with a polymerization initiator to obtain a monomer solution.

The polymerization initiator to be used is not particularly limited, and one or more polymerization initiators which have been known may be suitably used.

Examples thereof include peroxides such as dibenzoyl peroxide, dilauroyl peroxide, distearoyl peroxide, 1,1-di(t-butylperoxy)-2-methylcyclohexane, 1,1-di(t-hexylperoxy)-3,3,5-trimethylcyclohexane, 1,1-di(t-hexylperoxy)cyclohexane, 1,1,1-di(t-butylperoxy)cyclohexane, di-t-hexyl peroxide, t-butyl cumyl peroxide, di-t-butyl peroxide, 1,1,3,3-tetramethylbutyl peroxy-2-ethylhexanoate, t-hexyl peroxy-2-ethylhexanoate, t-butyl peroxy-2-ethylhexanoate, and t-butyl peroxyisopropylmonocarbonate; and azo compounds such as 2,2′-azobisisobutyronitrile, 2,2′-azobis-2-methylbutyronitrile, and 2,2′-azobis-2,4-dimethylvaleronitrile.

The organic solvent is used as a porosity-imparting agent, i.e., for imparting a porous structure to the polymer particles to be obtained. A hydrocarbon or an alcohol is suitable for use as this organic solvent. The hydrocarbon may be any of aliphatic and aromatic hydrocarbons having 5-12 carbon atoms, and the aliphatic hydrocarbons may be either of saturated and unsaturated hydrocarbons. Preferred examples of such hydrocarbons include toluene, n-hexane, n-heptane, n-octane, isooctane, undecane, and dodecane.

As the alcohol, it is preferred to use aliphatic alcohols. Of these, aliphatic alcohols having 5-12 carbon atoms are more preferred. Preferred examples thereof include 2-ethylhexanol, t-amyl alcohol, nonyl alcohol, 2-octanol, decanol, lauryl alcohol, and cyclohexanol.

According to the invention, a mixture of any of those hydrocarbons and any of those alcohols is also suitable for use as the organic solvent. The weight ratio of the hydrocarbon to the alcohol in this mixture varies depending on the specific hydrocarbon and alcohol used in combination. By suitably regulating this ratio, the porous structure of the porous polymer particles to be obtained, such as pore diameter distribution and specific surface area, can be variously controlled.

The amount of the organic solvent to be used for obtaining the monomer solution may preferably be in the range of 0.5 to 2.0 times by weight, more preferably in the range of 0.8 to 1.5 times by weight, the total amount of the monomers. In case where the organic solvent is used in an amount outside the range shown above, although it depends on combination with the monomers used, it is difficult to obtain truly spherical polymer particles. In addition, the porous polymer particles thus obtained do not have an even porous structure.

According to the invention, the monomer solution is dispersed in water containing a dispersant and sodium nitrite and the monomers are subsequently suspension-polymerized to yield porous polymer particles. The dispersant is not particularly limited. However, it is preferred to use a water-soluble polymer such as a poly(vinyl alcohol), poly(acrylic acid), gelatin, starch, carboxymethyl cellulose, hydroxyethyl cellulose, poly(sodium acrylate), or polyvinylpyrrolidone. These may be used alone or in combination of two or more thereof.

In the invention, it is especially preferred to use a poly(vinyl alcohol) as the dispersant. In particular, a poly(vinyl alcohol) having a degree of polymerization in the range of 500 to 3,000 and a degree of saponification in the range of 65 to 85 mol % is preferred. In case where a poly(vinyl alcohol) having a degree of polymerization lower than 500 is used, the suspension polymerization dispersion has impaired dispersion stability to yield a large amount of aggregates as well as a crosslinking reaction occurs among porous particles, making it difficult to obtain satisfactorily dispersed porous polymer particles. On the other hand, in case where a poly(vinyl alcohol) having a degree of polymerization higher than 3,000 is used, suspension polymerization gives a reaction mixture which has high viscosity and, as a result, has increased filtration resistance, making it difficult to separate the resultant porous polymer particles from the reaction mixture. With respect to the degree of saponification of poly(vinyl alcohol), a poly(vinyl alcohol) having a degree of saponification lower than 65 mol % is generally difficult to procure. On the other hand, when the degree of saponification is higher than 85 mol %, dispersion stabilizing effect is not sufficient, so that aggregated particles or coarse particles tend to generate.

The amount of the dispersant to be used in the invention is not particularly limited. However, the amount thereof is preferably in the range of 0.5 to 3% by weight based on the weight of the water present in the suspension polymerization dispersion. In case where the dispersant is used in an amount smaller than 0.5% by weight based on the weight of the water present in the suspension polymerization dispersion, this suspension polymerization dispersion has impaired dispersion stability to yield a large amount of aggregates as well as a crosslinking reaction occurs among porous polymer particles, making it difficult to obtain satisfactorily dispersed porous polymer particles. On the other hand, in case where the dispersant is used in an amount larger than 3% by weight based on the weight of the water present in the suspension polymerization dispersion, suspension polymerization gives a reaction mixture which has high viscosity and, as a result, has increased filtration resistance, making it difficult to separate the resultant porous polymer particles from the reaction mixture. In addition, use of the dispersant in such an excessive amount has drawbacks, for example, that the cost of impurity removal in the washing of the resultant porous polymer particles increases.

Reaction conditions in the suspension copolymerization, such as temperature and reaction time, in the invention may be suitably determined. For example, the copolymerization may be conducted by stirring the suspension polymerization dispersion in a nitrogen stream at a temperature of 60 to 90° C. for about 2 to 48 hours.

According to the invention, the monomer mixture and a polymerization initiator are dissolved in an organic solvent to prepare a monomer solution, this monomer solution is dispersed in water containing a dispersant and sodium nitrite, and a suspension polymerization is then carried out to thereby yield porous polymer particles, and on that occasion, the content of the sodium nitrite in the water is regulated to be in the range of 0.005 to 0.1 mg per 1 g of the water.

Sodium nitrite is generally known to function as a water-soluble polymerization inhibitor in suspension polymerization to inhibit monomers from unnecessarily polymerizing in the aqueous phase. For example, use of sodium nitrite for increasing the diameter of particles in the production of porous styrene/divinylbenzene polymer particles by the two-step swelling method has been reported (Journal of Polymer Science: Part A, Polymer Chemistry, Vol. 32, 2577-2588 (1994)). The report shows that as the amount of the sodium nitrite added to the water in the suspension polymerization dispersion increases, the diameter of the resultant particles increases, and that the particle diameter is maximal when the addition amount is 0.2 mg/mL or larger. Namely, by adding sodium nitrite to the water of the suspension polymerization dispersion at a concentration of 0.2 mg/mL or higher, a finely particulate polymer is inhibited from being unnecessarily yielded in the aqueous phase and a slight amount of the monomers migrated to the aqueous phase are resupplied, without polymerizing in the aqueous phase, to the particles which are undergoing a polymerization reaction, whereby the reaction proceeds.

However, according to the invention, in the production of porous polymer particles by the suspension polymerization of the aromatic vinyl monomer and the aromatic divinyl monomer, sodium nitrite is caused to be present in the water of the suspension polymerization dispersion in an amount in the range of 0.005 to 0.1 mg per 1 g of the water (5-100 ppm), preferably 0.02 to 0.05 mg per 1 g of the water (20 to 50 ppm). Due to the presence of sodium nitrite at such a concentration, the formation of a finely particulate polymer in the aqueous phase can be inhibited and a reaction mixture having excellent filterability can be obtained. Consequently, the porous polymer particles can be efficiently taken out by filtration and washed and impurities can thus be effectively removed. Accordingly, the target porous polymer particles can be obtained in high yield.

In case where sodium nitrite is present in the water of the suspension polymerization dispersion in an amount exceeding 0.1 mg per 1 g of the water, the yield of the target porous polymer particles is low and such a small sodium nitrite amount may arouse a trouble that polymer particles aggregate during the polymerization reaction. Conversely, in case where the amount of the sodium nitrite present in the water of the suspension polymerization dispersion is smaller than 0.005 mg per 1 g of the water, the yield of the porous polymer particles obtained is low also in this case. In addition, an unnecessary finely particulate polymer is yielded in the aqueous phase and this polymer, when porous polymer particles are separated from the resultant reaction mixture by filtration through a filter medium, clogs the filter medium, resulting in a considerably reduced filtration efficiency.

There is generally known a technique in which after suspension polymerization, a coagulant is added to the resultant reaction mixture containing porous polymer particles to cause the particles to undergo secondary aggregation, whereby the apparent diameter of the particles is increased to improve filtration efficiency. Examples of the coagulant include acids, water-soluble salts of polyvalent metals, and hydrophobic fine particles such as hydrophobic silica and hydrophobic zirconia. However, use of such coagulants necessitates washing for removing the coagulants thereafter and further poses a problem that the coagulants themselves may possibly be an impurity.

In contrast, according to the process of the invention, the porous polymer particles naturally undergo secondary aggregation during the suspension polymerization or when the reaction mixture is cooled to room temperature after the suspension polymerization, without the necessity of using any of those coagulants. As a result, the reaction mixture has further improved filterability, so that the porous polymer particles can be easily and efficiently separated from the reaction mixture by filtration. In addition, another feature of the process of the invention resides in that the secondary aggregates of the porous polymer particles naturally disaggregate, without any special operation, during the washing and filtration for removing the impurities contained in the porous polymer particles.

The porous polymer particles yielded by the process of the invention are not particularly limited in the particle diameter thereof. However, it is generally preferred that the median particle diameter thereof be in the range of 2 to 200 μm. In the case of porous polymer particles having a medium particle diameter larger than 200 μm, satisfactory filtration efficiency can be obtained by merely using a filter medium having a larger opening size, without relying on the invention. On the other hand, in the case of porous fine particles having a median particle diameter smaller than 2 μm, production itself by suspension polymerization is difficult. In this regard, median particle diameter as used herein is measured by particle size distribution measurement in accordance with the laser diffraction/scattering method.

Subsequently, the reaction mixture obtained in the manner described above is filtered to obtain a cake of porous polymer particles, and this cake is washed and optionally dried. Thus, the target porous polymer particles can be obtained.

Apparatus for filtering the reaction mixture are not particularly limited so long as the apparatus employ a filter medium. For example, use may be made of an apparatus for centrifugal filtration, vacuum/suction filtration, pressure filtration, or the like.

Since the cake of porous polymer particles obtained by filtering the reaction mixture contains impurities such as the dispersant and solvent, the cake is washed in order to remove the impurities. Specifically, a washing liquid is added to the cake, the resultant mixture is stirred to redisperse the porous polymer particles in the washing liquid, and the particles are then filtered again. This operation is repeatedly conducted to remove the impurities from the porous polymer particles.

Water such as ion-exchanged water, purified water, distilled water, or ultrapure water is, for example, used first as the washing liquid in order to remove the water-soluble dispersant contained in the reaction mixture. Subsequently, in order to remove the organic solvent, any of various organic solvents having satisfactory compatibility with that organic solvent is ordinary used as a washing liquid. Examples of the organic solvent for use as a washing liquid include organic solvents having a relatively low boiling point, such as methyl alcohol, ethyl alcohol, propyl alcohol, hexane, toluene, and acetone. Such solvents may be used alone or in combination of two or more thereof according to the organic solvent used for the suspension polymerization. In the case where it is necessary that the cake of porous polymer particles obtained through the washing should be dried, it is advantageous to employ methanol, acetone, hexane, or the like from the standpoints of solvent cost and the cost of power for the drying.

In the invention, the filter medium is not limited at all. For example, use may be made of a filter paper, stainless-steel sintered filter, glass-fiber filter paper, sintered glass filter, filter cloth made of polypropylene or polyethylene, nylon mesh, or the like. Of these, a single-layer nylon mesh is preferred because this filter medium combines chemical resistance, strength, and satisfactory filtering properties and is thin, lightweight, and easy to handle. The opening size of the nylon mesh is not particularly limited, and may be suitably selected according to the particle diameter of the porous polymer particles to be produced. Preferred is a nylon mesh whose opening size is from 1/10 to ¾ the particle diameter.

Filtration apparatus are not particularly limited so long as the filtration apparatus employs a filter medium. For example, use may be made of an apparatus for centrifugal filtration, vacuum/suction filtration, pressure filtration, or the like.

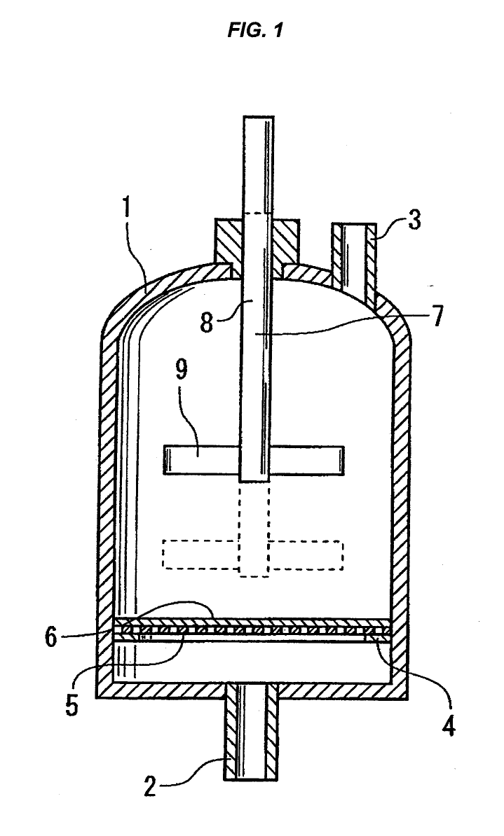

One example of filtration apparatus which are preferred for use in the invention is shown in FIG. 1. This filtration apparatus includes a cylindrical vessel 1, which has, in a bottom part thereof, a drainage opening 2 for a filtrate resulting from the filtration of a dispersion. The vessel 1 further has, in an upper part thereof, an upper opening 3 for supplying pressurized air to the inside of the vessel according to need.

In a lower part of the vessel, a filter medium holding frame 4 in a ring form is disposed along the peripheral wall. On this holding frame is placed a filter medium support 5 through which solvents can pass. This filter medium support, for example, is a metallic plate having a lot of through-holes formed therein or a metallic gauze. However, the filter medium support should not be construed as being limited to these examples. A filter medium 6 is placed on the filter medium support.

The vessel is further equipped with a stirrer 7. This stirrer includes a shaft 8 supported at a top part of the vessel so as to be rotatable and be vertically movable within the vessel in the axial direction therefor. The stirrer further includes stirring blades 9 disposed at the lower end of the shaft and extending in radial directions for the vessel.

This filtration apparatus may be used in the following manner. A reaction mixture obtained by the suspension polymerization described above, i.e., a mixture containing porous polymer particles and further containing water, an organic solvent, and a dispersant, is charged into the filtration apparatus and subjected to, for example, suction filtration to obtain a cake of the porous polymer particles. Water is added to this cake, and the mixture is stirred to redisperse the cake in the water and the particles are washed and are then subjected again to suction filtration. This operation is repeated to obtain a cake. Furthermore, a suitable organic solvent, e.g., acetone, is added to the cake, and the mixture is stirred to redisperse the cake in the acetone and the particles are washed and are then subjected likewise to suction filtration to obtain a cake of the porous polymer particles. Acetone is added again to this cake, the mixture is stirred, and the particles are washed and are then subjected to suction filtration. This operation is repeated and, thereafter, the cake is dried with heating according to need. Thus, the target porous polymer particles can be obtained as a powder.

### EXAMPLES

### Example 1

(Suspension Copolymerization)

A separable flask having a capacity of 500 mL and equipped with a condenser, stirrer, and nitrogen introduction tube was placed in a thermostatic water bath. Into this flask were introduced 240 g of purified water and 2.4 g of a poly(vinyl alcohol) (manufactured by Kuraray Co., Ltd.; average degree of polymerization, about 2,000; degree of saponification, 79 mol %). The temperature of the thermostatic water bath was kept at 28° C., and the poly(vinyl alcohol) was dissolved in the water with stirring. Subsequently, an aqueous sodium nitrite solution having a concentration of 0.5 mol/L was added to and dissolved in the poly(vinyl alcohol) solution so as to result in a sodium nitrite concentration in the water of 0.005 mg/g.

Separately from the operation described above, 1 g of dibenzoyl peroxide (containing 25% water) was added to and dissolved in a mixture of 44 g of styrene, 3 g of p-acetoxystyrene, and 7 g of divinylbenzene. Furthermore, 50 g of 2-ethylhexanol and 20 g of isooctane were added to and mixed with the solution. The resultant solution was added to the aqueous poly(vinyl alcohol) solution containing sodium nitrite.

The mixture thus obtained was stirred in a nitrogen stream at 470 rpm for 40 minutes. Thereafter, the speed of stirring rotation was changed to 280 rpm and the temperature of the thermostatic water bath was raised from 28° C. to 80° C. A suspension copolymerization reaction was conducted for 9 hours. After completion of the reaction, the thermostatic water bath was cooled to 28° C.

(Filtration)

A filtration apparatus having the following constitution was used. As shown in FIG. 1, the filtration apparatus includes a cylindrical vessel 1 having an inner diameter of 9 cm and a filter medium 6 (manufactured by NRK; nylon mesh; opening size, 45 μm) disposed in a bottom part of the vessel 1. The vessel 1 further has a drainage opening 2 for discharging a filtrate which has passed through the filter medium. The vessel furthermore includes a shaft 8 supported at a top part of the vessel and movable vertically in the axial direction for the vessel. Stirring blades 9 is attached to the lower end of the shaft.

The reaction mixture obtained by the suspension polymerization was wholly charged into the filtration apparatus. The drainage opening at the bottom of the vessel was connected to an aspirator, and suction filtration was conducted at a reduced pressure to obtain a cake of porous polymer particles. The position of the stirring blades during this filtration is indicated by solid lines in FIG. 1.

(Washing)

To the resultant cake of porous polymer particles was added 200 mL of purified water. The shaft of the stirrer was rotated while being gradually lowered from an upper part of the vessel. The cake in the vessel was thus stirred together with the water by means of the stirring blades to sufficiently disperse the cake in the water. This mixture was filtered again to obtain a cake of porous polymer particles. This operation was repeated four times. For the stirring, the stirring blades were lowered, while being rotated, from the position indicated by solid lines to the position indicated by broken lines in FIG. 1.

Subsequently, 200 mL of acetone was added to the cake of porous polymer particles thus obtained, and the porous polymer particles were washed and taken out by filtration in the same manner. This operation was repeated three times.

(Yield)

The cake of porous polymer particles thus washed was dried in a 70° C. vacuum dryer for 48 hours. After the drying, the porous polymer particles obtained were weighed to determine the yield thereof.

### Examples 2 to 5

Suspension copolymerization, filtration, and washing were conducted in the same manners as in Example 1, except that an aqueous sodium nitrite solution having a concentration of 0.5 mol/L was used to regulate the content of sodium nitrite in the water to each of the values shown in Table 1. The yield of the porous polymer particles obtained was determined in the same manner as in Example 1.

### Comparative Example 1

Suspension copolymerization, filtration, and washing were conducted in the same manners as in Example 1, except that sodium nitrite was not used. The yield of the porous polymer particles obtained was determined in the same manner as in Example 1.

### Comparative Examples 2 to 4

Suspension copolymerization, filtration, and washing were conducted in the same manners as in Example 1, except that an aqueous sodium nitrite solution having a concentration of 0.5 mol/L was used to regulate the content of sodium nitrite in the water to each of the values shown in Table 1. The yield of the porous polymer particles obtained was determined in the same manner as in Example 1.

In Table 1 are shown the state of aggregation of porous polymer particles in suspension copolymerization, the efficiency of filtration of the reaction mixture obtained by the suspension copolymerization, the efficiency of washing with water, the efficiency of washing with acetone, the yield of porous polymer particles, the median particle diameter of the porous polymer particles obtained, and the results of an examination of the surface of the particles with a scanning electron microscope (SEM), with respect to each of Examples 1 to 5 and Comparative Examples 1 to 4.

TABLE 1

| | Comparative | | | | | | | Comparative | |
|---|---|---|---|---|---|---|---|---|---|
| | Example | | Example | | | | | Example | |
| | 1 | 2 | 1 | 2 | 3 | 4 | 5 | 3 | 4 |
| Content of sodium nitrite (mg/g) | 0 | 0.001 | 0.005 | 0.02 | 0.05 | 0.075 | 0.1 | 0.2 | 0.5 |
| Aggregation of porous polymer particles | none | none | none | a | a | a | b | b | b |
| Efficiency of filtration of reaction mixture | very poor | poor | fair | good | good | good | good | good | good |
| Filtration efficiency in water washing | very poor | poor | fair | good | good | good | good | good | good |
| Filtration efficiency in acetone washing | poor | slightly | good | good | good | good | good | good | good |
| | | poor | | | | | | | |
| Yield of porous polymer particles (%) | 75 | 77 | 83 | 83 | 82 | 80 | 78 | 72 | 67 |
| Median particle diameter (μm) | 97 | 94 | 97 | 98 | 93 | 88 | 95 | 84 | 90 |
| SEM examination of particle surface | uneven | uneven | good | good | good | good | good | good | good |
| Comprehensive rating | poor | poor | good | excellent | excellent | excellent | good | poor | poor |

(Note)
“a” means that secondary aggregation occurred after polymerization reaction.
“b” means that secondary aggregation occurred during polymerization reaction.

In each of Examples 1 to 5, both the efficiency of filtration of the reaction mixture obtained and the efficiencies of filtration in the water washing and acetone washing of the cake of porous polymer particles were satisfactory. The porous polymer particles were able to be efficiently taken out by filtration, washed, and separated and impurities were able to be effectively removed, whereby the porous polymer particles were able to be obtained in a high yield. The surface of the porous polymer particles obtained in each of Examples 1 to 5 was examined with a scanning electron microscope. As a result, no “unevenness” was observed in each porous particulate polymer and the porous structure was found to be even. Furthermore, in Examples 2 to 5, the porous polymer particles yielded underwent secondary aggregation during the suspension polymerization or when the reaction mixture was cooled to room temperature after the suspension polymerization.

More specifically, according to Examples 1 to 5, each of the efficiency of filtration of the reaction mixture, the filtration efficiencies in water washing and acetone washing, the yield of porous polymer particles, and the results of the SEM examination of the particle surface was able to be rated at least as “fair”. In particular, according to Examples 2 to 4, the efficiencies of each filtration operation and the yield of porous polymer particles were all good and, hence, the comprehensive rating was “excellent”.

On the other hand, in Example 1, the efficiency of filtration of the reaction mixture and the filtration efficiency in water washing were rated as “fair”. In Example 5, the yield of porous polymer particles was somewhat lower than in the other Examples. The comprehensive rating of Examples 1 and 5 was hence “good”.

In Comparative Example 1 and Comparative Example 2, on the other hand, not only the efficiency of filtration of the reaction mixture obtained by suspension polymerization but also the filtration efficiencies in the water washing and acetone washing of the cake of porous polymer particles was poor. The surface of the porous polymer particles obtained in each of Comparative Examples 1 to 4 was examined with a scanning electron microscope. As a result, “unevenness” was observed which seemed to indicate that pores of the particles had been clogged. Namely, the porous structure thereof was uneven. Consequently, the comprehensive rating of Comparative Examples 1 to 4 was “poor”.

While the present invention has been described in detail and with reference to specific embodiments thereof, it will be apparent to one skilled in the art that various changes and modifications can be made therein without departing from the scope thereof.

This application is based on Japanese patent application No. 2008-136393 filed May 26, 2008, the entire contents thereof being hereby incorporated by reference.

Further, all references cited herein are incorporated in their entireties.

What is claimed is:

1. A process for producing porous polymer particles, which comprises:
dissolving in an organic solvent a monomer mixture comprising an aromatic vinyl monomer and an aromatic divinyl monomer as major components together with a polymerization initiator to obtain a monomer solution;
dispersing the monomer solution in water containing a dispersant and sodium nitrite to obtain a suspension polymerization dispersion;
suspension-polymerizing the monomers in the suspension polymerization dispersion to yield porous polymer particles; and
separating the porous polymer particles by filtration through a filter medium,
wherein the sodium nitrite is incorporated into the water in an amount in the range of 0.005 to 0.1 mg per 1 g of the water.

2. The process according to claim 1, wherein an amount of the organic solvent in the suspension polymerization dispersion is in the range of 0.5 to 2.0 times by weight a total amount of the monomers.

3. The process according to claim 1, wherein the aromatic vinyl monomer and the aromatic divinyl monomer account for at least 50% by weight of the monomer mixture.

4. The process according to claim 1, wherein the aromatic vinyl monomer is styrene and the aromatic divinyl monomer is divinylbenzene.

5. The process according to claim 1, wherein the monomer mixture includes p-acetoxystyrene.

6. The process according to claim 1, wherein the dispersant is a poly(vinyl alcohol) having an average degree of polymerization in the range of 500 to 3,000 and a degree of saponification in the range of 65 to 85 mol %.

7. The process according to claim 1, wherein the porous polymer particles have a median particle diameter in the range of 2 to 200 μm.

8. The process according to claim 1, wherein the amount of the aromatic divinyl monomer is in the range of 2 to 30% by weight based on the total weight of the aromatic vinyl monomer and the aromatic divinyl monomer.
